(19) United States
(12) Patent Application Publication
(10) Pub. No.: US 2024/0330027 A1
(43) Pub. Date: Oct. 3, 2024

(54) Record Templates

(71) Applicant: Formagrid Inc, San Francisco, CA (US)

(72) Inventors: Helen Wei Zeng, Oakland, CA (US); Kevin Jonathan Kuo, New York, NY (US); Adrianne Claire Ngam, San Francisco, CA (US); Justin Chiayin Liu, New York, NY (US); Emily Yiming Cai, San Mateo, CA (US); Kristof Arnold Didrickson, San Francisco, CA (US); Ankur Saxena, San Jose, CA (US)

(21) Appl. No.: 18/620,359

(22) Filed: Mar. 28, 2024

Related U.S. Application Data
(60) Provisional application No. 63/492,727, filed on Mar. 28, 2023.

(51) Int. Cl. G06F 9/451; G06F 16/21; G06F 40/186

(52) U.S. Cl. CPC G06F 9/453; G06F 16/213; G06F 40/186

(57) ABSTRACT

A database system provides templates that can be applied to create new data objects. The database system may instantiate a data object having fields that are dynamically calculated based on data in other data objects. In some instances, the database system may dynamically calculate start or end dates for a project based on another date in another project. Data objects and templates can be linked in various dependencies, such as a parent template that can be linked to multiple children templates in a linear order, where the database system can update a value at the parent template and automatically have the update flow through the sequence of children templates due to the linked relationship.

### CROSS-REFERENCE TO RELATED APPLICATIONS

This application claims the benefit of U.S. Provisional Application No. 63/492,727, filed Mar. 28, 2023, which is incorporated by reference.

### BACKGROUND

### 1. Technical Field

The subject matter described relates generally to databases and, in particular, to techniques for applying record templates to data to create interrelated and updateable records in a repeatable and scalable way.

### 2. Background Information

Databases are commonly used in project management because they provide an efficient mechanism to track tasks, resources, and dependencies. However, in many cases, the database for a given project is designed and built specifically for that project. Despite similarities in workflow to earlier projects, it can be difficult to make use of prior projects to efficiently create new projects. For example, a user may manually copy workflows from one project to another, but this is time consuming and prone to errors. Automations and scripting may be used to semi-automate the process, but this requires a detailed understanding of both the records and schema used in the projects, and still must be tailored to the specific use case. There is thus a need for a mechanism to automatically create lists of tasks and relationships between them.

### SUMMARY

The above and other problems may be addressed by a database system that provides record templates that can be applied to data to create one or more records across tables for a project. Note that although these record templates are described in the context of creating task lists for project management, the same or similar principles may be applied in other contexts where it is useful to automatically generate records with predetermined relationships from underlying data in a repeatable and scalable way.

In one embodiment, the database system enables one of more of the following: adding/editing/dragging projects/tasks/subtasks with inherent hierarchical relationships; checking all projects/tasks/subtasks assigned to an individual in one place; checking all notifications that relate to an individual's projects/tasks/subtasks in one place; creating new task templates or templatize existing projects/tasks to create repeatable workflows; managing and planning individual tam capacity; and creating additional dependencies between projects/tasks/subtasks. The system may enable dynamic calculation of start/end dates for projects/tasks/subtasks at the time of instantiating a workflow using a record template.

### BRIEF DESCRIPTION OF THE DRAWINGS

FIG. 1 is a block diagram of a networked computing environment suitable for using record templates, according to one embodiment.

FIG. 2 is a block diagram of the server of FIG. 1, according to one embodiment.

FIG. 3 is a block diagram of a portion of the databases of FIG. 2, according to one embodiment.

FIG. 4 illustrates multisource synchronization of three tables of three databases in the databases, according to one embodiment.

FIG. 5 depicts a diagram for instantiating data objects using a record template module, in accordance with at least one embodiment.

FIG. 6 is a diagram illustrating a process for incorporating a record template into a dependency graph for a database, according to one embodiment.

FIG. 7 depicts a first type of relationship between a parent data object and a child data object, in accordance with one embodiment.

FIG. 8 depicts a second type of relationship between a parent data object and child data objects, in accordance with one embodiment.

FIG. 9 depicts a graphical user interface for adding, modifying, and linking templates, in accordance with one embodiment.

FIG. 10 illustrates a method for instantiating a data object, in accordance with one embodiment.

FIG. 11 is a block diagram illustrating an example of a computer suitable for use in the networked computing environment of FIG. 1, according to one embodiment.

### DETAILED DESCRIPTION

Templates are advantageous to provide relative values (e.g., date values) when records are instantiated. In one embodiment, date values of child data objects are encoded relative to a parent data object's value. Thus, the present system enables templated records to be populated with dynamically updatable values when instantiated. If these records were instantiated using a template with static values, the records are likely to have out-of-date values (e.g., dates that have already passed) for child data objects (e.g., subtasks) and would need to be manually adjusted after instantiation. In this way, the present system maintains accurate records automatically (i.e., without a user manually updating the values).

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Example Systems

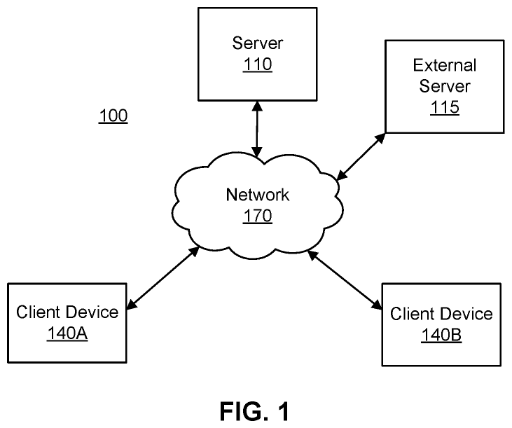

FIG. 1 illustrates one embodiment of a networked computing environment 100 suitable for providing and using record templates. In the embodiment shown, the networked computing environment 100 includes a server 110, an external server 115, a first client device 140A, and a second client device 140B, all connected via a network 170. Although two client devices 140 are shown, the networked computing environment 100 can include any number of client devices 140. Similarly, although one external server 115 is shown, the networked computing environment 100 can include any number of external servers 115. In other embodiments, the networked computing environment 100 includes different or additional elements. In addition, the functions described herein may be distributed among the elements in a different manner than described.

The server 110 hosts multiple databases. In one embodiment, the server 110 performs synchronization between databases with a cross-base synchronize function. The cross-base synchronize function copies data from a shared source view to a target table. Data may be copied in one direction during a synchronization. When a synchronization completes, the target table contains all of the rows in the source view and cell data for all columns (alternatively, “fields”) selected to be synchronized. Data (rows and columns) copying may be limited to only rows that are explicitly or implicitly set as ‘visible’ in the shared view. Users may determine what data is available to synchronize (and in what form) using a shared view interface (e.g., to designate one or more rows or columns as visible or not visible). As described in further detail below, a user can synchronize some or all data from one or more sources to a target table, and one or more of the sources can be external to the server 110, e.g., may be hosted by an external server 115.

In an embodiment, data in the target table matches the format of the data in the shared view interface. For example, if linked records are rendered as text in shared views, they also render as text in the target table. Formulas may render as their result type and look like a non-formula field. As a consequence of this design, synchronization does not differentiate between data being deleted from the source table or simply being hidden from the shared view. As described in further detail below, matching data from source to target table can follow an alternative technique.

The following table illustrates the mapping between source and target data types for one embodiment:

| Source type | Target type |
|---|---|
| Number/date/single-line text/long | Identical type and configuration (e.g., |
| text/rich text/select/multi-select | number/date formatting, select |
| | color and order) |
| Foreign key | Text |
| Collaborator/Multi-collaborator | Text |
| Lookups | As the looked-up type (so |
| | synchronizing a lookup of a foreign |
| | key will result in text) |
| Formulas/Rollups | As the result type |
| Button fields | ‘Open URL’ type button fields will |
| | be synchronized as URL field |
| Attachments | As-is |

A synchronized target table mirrors the contents of its source view but can contain additional unsynchronized columns to enrich the synchronized data. For example, one might collect T-shirt sizes for all employees by synchronizing into the target table a list of employees and then adding an unsynchronized ‘T-shirt size’ column, where each employee enriches the target table by entering their T-shirt size to a respective row at the ‘T-shirt size’ column.

In an embodiment, users of the target table are not allowed to create or destroy records in the synchronized portion of the table, nor to change cell values or column type and type options for any synchronized column, but they can make changes to non-synchronized columns. In some embodiments, users of the target table may change the names and descriptions for synchronized columns, which does not impact the source table (i.e., source view) but changes how the synchronized data is displayed in the target table (e.g., a column in the target table has a different name than the corresponding column in the source table).

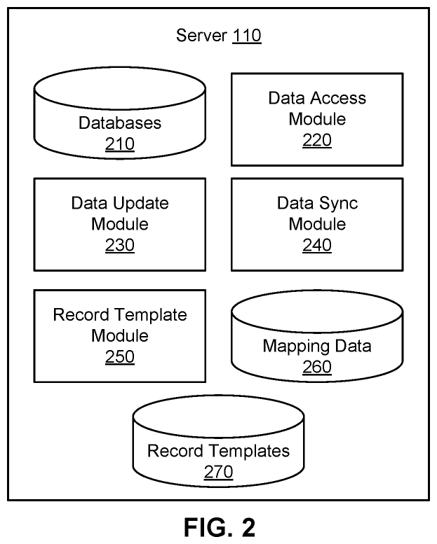

The server 110 also provides templates that may be applied to data to create new data records with predetermined relationships. A template is a preset format for a data object, which the server 110 can access to create data objects having that format. For example, the server 110 can create multiple workflows for an event planner, where each workflow is for renting a different item for an event. The template can include the same fields for each rental (e.g., name of object being rented, name of renter, start and end date of rental, etc.). The terms “record template” and “row template” may be used interchangeably. In one embodiment, a record template creates a workflow including tasks (and optionally subtasks) for a project in a repeatable and scalable way. The specific values of various fields (e.g., start and end dates for various tasks) are determined dynamically when the project is created using the template. For example, the first task in a project may be set to begin on the current date—the date the project is created—and complete three days later while a follow-up task, that requires completion of the first task, is set to begin three days after the current date. Various embodiments of record templates (and other aspects of the server 110) are described in greater detail below, with reference to FIG. 2.

The client devices 140 are computing devices with which users can access and edit the databases managed by the server 110. Example client devices include desktop computers, laptop computers, smartphones, tablets, etc. The client devices 140 may enable users to interact with the databases via a user interface accessed via a browser, a dedicated software application executing on the client devices, or any other suitable software.

The external server 115 is a server, which may be associated with a different entity than the server 110. For example, server 110 is associated with a first organization, and server 115 is associated with a second organization. The external server 115 may be, for example, a SALESFORCE server, a JIRA server, a GOOGLE CALENDAR server, or a BOX server. Users of client devices 140 can synchronize data from source tables in databases hosted at the external server 115 to target tables at the server 110. This can involve the user providing credential information, which the server 110 uses to connect to the external server 115.

The server 110 can synchronize data from the external server 115 to a target table in a database of the server 110. In one embodiment, the server 110 stores a tabular data mapping to translate data from the external server 115 to a usable format for server 110 databases. The server 110 may store a different tabular data mapping for each of multiple external servers 115 to facilitate data transfer to the target table. For example, the server 110 may store a first tabular data mapping for SALESFORCE reports that uses a SALESFORCE application programming interface (API), a second tabular data mapping for JIRA issue filters that uses a JIRA API, and a third tabular data mapping for GOOGLE CALENDAR events that uses a GOOGLE CALENDAR API. Using the API of an external server 115, the server 110 can request and receive synchronized data for a target table. For example, the server 110 may send a query to the external server 115 using a respective API function, where the query specifies the data to be synchronized to the target table, and then the server 110 receives, via a different API function, query results including the synchronized data from the external server 115. The server 110 identifies an external server 115, fetches the respective tabular datamapping, and uses the respective tabular data mapping to synchronize data from the external server 115 (e.g., to a target table).

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, all or some of the communication links of the network 170 may be encrypted using any suitable technique or techniques.

A user of client device 140A can interface with the server 110 to create a synchronized target table according to one or more techniques, depending upon the embodiment. The user interface may be exposed by the server 110 or client device 140A. In one embodiment, the user receives a link to a shared view (e.g., from an administrator of the database including the shared view). The user provides an instruction the server 110 to use the link to initiate a synchronization, either with a new table or an existing table. The server 110 sets up the requested synchronization between the shared view and the selected table. In one embodiment, the user selects a widget of a user interface exposed by the server 110 that displays a shared view to create a new synchronized table using the shared view.

In an embodiment, the link to the shared view may be temporary, e.g., only useable once, or for a finite period of time, such as 24 hours. Thereafter, the source table may be identified by a source table identifier. In this manner, the source table can be secured, such that if the user ends synchronization to the target table, the link cannot be used to inappropriately gain access the source table. In an embodiment, a user that shares a like to a shared view to another user may revoke access to the shared view from the other user.

In one embodiment, the user has access permission to the source table and the target table. The user can create a new shared view or enable synchronization of an already-existing shared view. The user can then proceed with one of the above techniques. Alternatively, the user can navigate to a user interface that displays the target table and select a widget to expose a list of potential source tables. The user can select the shared view to use it as a source table. In various embodiments, the user can set a table (e.g., for which the user has access permission) as able to be synchronized (i.e., can be used as a source table) or not. In various embodiments, the user can designate some or all of the rows or columns in the table as able to be synchronized or not.

In an embodiment, the user can restrict access to the table such that it is password protected. The user can restrict access to the table such that only users associated with specified email addresses or email domains can access the table.

In one embodiment, if a source table is password-protected, the user initiating synchronization to a target table is prompted to correctly enter the password to the source table in order to set up the synchronization. Once the password has been entered, synchronization may operate automatically, indefinitely, or for a predetermined time period (e.g., one month or one year) without requiring password reentry. If the password changes, or if a password is added to a previously unprotected source table, the synchronization stops working until authenticated or reauthenticated. In an embodiment, the user can revoke access temporarily or permanently.

In one embodiment, if a source table is email domain-protected, the user initiating the synchronization needs to have a verified email with a permissioned domain to set up the synchronization. If the initiating user's email address with the permissioned domain is deactivated, suspended, or otherwise made inactive, the synchronization may cease to operate. Alternatively, a synchronization may remain operational as long as any user of the target table has an email address with a permissioned domain.

In an embodiment, the user can add one or more external source tables to a synchronized table by selecting an external source widget in the user interface. The user can then pick another source type (e.g., AIRTABLE, SALESFORCE, or JIRA.), select the source table within that type, and then map the fields from the new source table to the fields in the existing table. For each column in the target table, the user interface displays a list of columns in the source table, from which the user can select one column in the source table to associate with the column in the target table (e.g., such that data from the column in the source table is synchronized to the respective column in the target table).

In some embodiments, when adding a new source, the server 110 tries to match column names to existing column names, as described in further detail below. For columns that cannot be matched, the default option may be to synchronize that data to a new column in the target table instead. The user can change any mappings or opt to synchronize any source column to a new synchronized column.

In an embodiment, an option to select all columns is not available when there are multiple synchronization sources. When the user adds a new source table, if an existing source table is configured to synchronize all columns, that source table is changed to synchronize specific columns only. The user can use the user interface to alter the field mapping by selecting a widget to change mappings. In an embodiment, synchronized target tables that do not synchronize from multiple source tables do not include a field mapping. Rather, the target table uses the fields of the source synchronization table.

In an embodiment, after a synchronization is initiated for a target table from a source table, for every source table field, the user can select a new target table field in a dropdown of the user interface to change the target table field associated with the source table field.

Alternatively or additionally, the user can uncheck a field in the user interface to stop synchronizing data from this source table to the mapped target table field, where, if this source table was the primary source, the synchronized target table column will be destroyed.

The user can synchronize to a new target table field, where if the source table field was previously mapped to a target table field and the source table was the primary source, the synchronized field may be destroyed, and the data mapped to a new field instead. If the source table was not the primary source, the data may be mapped to a new field. If the source table field was previously unmapped, the data in the source table field may be mapped to a new target table field.

In an embodiment, the user can reconfigure, using the user interface, a selection of one or more columns to synchronize to a target table from a source table. The user can reconfigure a synchronization frequency with which the target table synchronizes to the source table.

The user can reconfigure whether deleted or hidden rows in the source table are deleted in the target table, where if the user does not choose to delete rows, rows will remain in the target table even after they are deleted in the source table (these rows can be removed by the user).

The user can remove a source table, which removes all rows associated with the source table. Alternatively, or additionally, the user can turn off synchronization functionality for the target table, which converts the target table into a normal (e.g., unsynchronized) data table.

The user can undo a reconfiguration, which restores the previous set of selected fields, the old synchronize frequency, the old row deletion setting, and so on; however, the availability of the fields and the cell values in the fields remains up to date, since the values come from the source table, and as such they are not reverted to their data from before the reconfiguration.

The user can trigger a manual synchronization by clicking a widget of the user interface to initiate a synchronization. The user can do this even when the table is configured to synchronize automatically. This allows the user to synchronize the target table without having to wait for the next scheduled synchronization.

In an embodiment, removing all synchronizations to source tables from a target table causes the target table to convert into a normal table that is not synchronized. No data is removed from the target table, but no future changes to source tables are synchronized to the target table. Depending upon the embodiment, this action may not be able to be undone.

In one embodiment, a user can add a button field to the target table and set label text and a color of their choice, where the button links to the source table. When another user clicks this button, the source table opens to the corresponding record in the source table in a new tab of the user interface (if the other user has access permission). For another user that has access to both the source table and target table, the other user can view unsynchronized fields of that source table or make changes to the source table. If the user has configured the target table to not delete rows that are hidden or deleted in the source table, the button may be unable to be selected or visually distinguished when the source record is hidden or deleted. Depending upon the embodiment, formulas or view filters may consume the output of the button field, e.g., the output of the button field can be a link of the source table's record, or null if the source table's record is no longer available.

In one embodiment, if a target table is duplicated, the duplicate table has the same configuration as the original target table. If the user deletes a target table, then restores it, the target table may regain its original configuration from before its deletion.

In an embodiment, the user can change one or more column names or descriptions of the synchronized portion of the target table. This can be used to rename columns to be more appropriate for the target table, for example. In an embodiment, when a user hovers over a column icon in the user interface, they can see the name of the respective source table column (if the target column has a different name). Depending upon the embodiment, the user may or may not be able to add a row, destroy a row, reconfigure a synchronized column, or edit a cell in a synchronized column.

The following Table 1 illustrates a correspondence of actions taken upon a source table and responsive changes in a target table subsequent to a synchronization, according to one embodiment:

TABLE 1

| Source table action | Target table behavior on next synchronization |
|---|---|
| Destroy/hide column | Destroy column |
| Undestroy/unhide column | Undestroy column if possible/else create a new |
| | column. |
| Add column | If ‘synchronize all fields’ is enabled, add column |
| Add row | Row will be added to the target table |
| Destroy/hide row | If ‘synchronize deletions’ is enabled: destroy row |
| | Otherwise: the “open source record” button gets |
| | disabled |
| Change cell values | Change cell values (based on type conversion) |
| Change filters | The set of visible rows will be synchronized |
| Reorder rows | No impact |
| Change column configuration to | Destroy column |
| unsupported type/configuration | |
| Change column configuration to | Change column config (based on type conversion) |
| supported type/configuration | |
| Disable synchronizing | Synchronizing stops working |
| Re-enable synchronizing | Synchronizing resumes |
| Delete view | Synchronizing stops working |
| Undestroy view | Synchronizing resumes |
| Change share URL | Synchronizing stops, requires re-authentication |
| Add/change shared view password | Synchronizing stops, requires re-authentication |
| Add domain restriction that the user | Synchronizing stops, requires re-authentication by a |
| does not satisfy | user in the target table with the appropriate domain |

In an embodiment, synchronization may be two-directional between two tables, where each table acts as a source table and a target table, and synchronized data added to either table is propagated to the other upon a subsequent synchronization.

In an embodiment, a user can generate a view-only link to send to another user, which the other user can use to view the target table only (i.e., the other user cannot edit the target table). Alternatively, or additionally, the user can set a user (e.g., by identifier or email address) or a domain as view-only, where the respective one or more users can view but not edit the target table.

In an embodiment, if a field mapping from one source table column to one target table column is removed (e.g., by the user), then added back, the server 110 attempts to restore the same column (thus restoring any lookups that reference that column, or calendars that use it as the date field, etc.). If the server 110 cannot restore the original column, a new column is created instead.

In an embodiment, if a field of a source table was previously synchronized but has since been made unable to be synchronized (e.g., by an administrator of the source table), the user interface may display the source table column as visually distinct (e.g., faded out or an alternative color) than other source table columns. The user can toggle whether to synchronize currently unavailable fields, though they do not appear when the user toggles them on. Only fields that are currently available from the source table, along with any currently selected but unavailable fields, appear in the field list.

FIG. 2 illustrates one embodiment of the server 110. In the embodiment shown, the server 110 includes a databases 210, a data access module 220, a data update module 230, a data synchronize module 240, a record template module 250, mapping data 260, and record templates 270. In other embodiments, the server 110 includes different or additional elements. In addition, the functions may be distributed among the elements in a different manner than described.

The databases 210 are stored on one or more computer-readable media. Although the databases 210 are shown as a single element within the server 110 for convenience, the databases 210 may be distributed across multiple computing devices (e.g., as a distributed database). Similarly, individual databases may be hosted by client devices 140 (or other computing devices) with the server 110 managing synchronization between databases but not storing the databases themselves.

The data access module 220 provides a mechanism for users to access data in one or more databases. In one embodiment, the data access module 220 receives a request from a client device 140 indicating an identifier of the requesting user (e.g., a username or user identifier) and data from a specified table in a specified database that the user wishes to view. The data access module 220 determines whether the user has permission to access the requested data and, if so, provides it to the client device 140 from which the request was received for display to the user.

The data update module 230 provides a mechanism for creators and their collaborators to edit data in and add data to databases. In one embodiment, the data update module 230 receives a request from a client device 140 indicating an identifier of the requesting user and data to be added to or amended into a specified table in a specified database. The data update module 230 determines whether the requesting user has permission to edit the specified table and, if so, updates the specified table in the databases 210 as requested.

The data synchronize module 240 updates some or all portions of target tables to synchronize them with the corresponding source table (or tables). In one embodiment, the data synchronize module 240 periodically (e.g., for a length of time ranging from one second to one hour, such as every five minutes, every hour, etc.) checks the one or more source tables and, if there is updated data available, imports it into the corresponding one or more target tables (e.g., updates records in the target table with respective records from the source table). Additionally, or alternatively, users of a target table may force a manual synchronization to one or more source tables (e.g., by selecting a control in the user interface).

The record template module 250 provides users access to templates and uses the templates to generate new records or modify existing records. In one embodiment, a record template mirrors the schema, or structure, of the record that the server 110 creates using the record template. Unlike a conventional template, which has a series of fields that a user manually fills out to make a document, a record template can be applied to existing data to create a new record (or set of records). That is, the record template may define a hierarchy and/or set of relationships for the new record that can be populated by applying the template to data and dynamically calculating values where needed. Because the server 110 may, using a record template, calculate values dynamically when the new record is created, or instantiated, record templates can be combined with parent-child relationships. That is, one record template can call another record template. For example, the server 110 may use a first record template to create a project including multiple tasks and, for some or all of the tasks, apply an additional template that creates subtasks within the corresponding task. Examples of relationships organized by a hierarchy can be between a record template and linked children templates, between a table of the template and linked children templates, or between a pre-instantiated data object and linked children templates. The terms “children” and “child” may be used interchangeably (e.g., “children data objects” and “child data objects” are interchangeably used).

The record template module 250 may define a template. The record template module 250 may receive inputs from a user to define the template. In some embodiments, the record template module 250 may define a template based on an existing data object. A template may include fields having a schema, or a “template schema,” where the schema includes an arrangement of the fields and definitions for data content of each field. A data content is stored within a field. For example, data is stored in a field of a table. The arrangement of fields may specify an order of the fields. A definition may be a formulaic determination of a value stored within a field. A definition for each field may be relative, or a “relative definition.” That is, the relative definition may specify that a data value depends on another data value. For example, a definition for a deadline specifies that the value is a number of days offset from a date specified in another data value. Other examples of a relative definition includes a date modification, geographic modification, duration modification, budget modification, or any suitable calculation that requires dependency between data values.

To calculate the value of a field using a relative definition, the record template module 250 may identify a value of a base parameter, determine a dependent offset based on the base parameter, and modify the value of the base parameter using the dependent offset. In one example, the record template module 250 may identify an end date of a first event as a base parameter, determine a ten-day dependent offset based on the end date (e.g., the end date is a deadline that may be extended by a period of ten days with a fee payment), and add ten days to the end date to determine the extended deadline (i.e., the field of the data object to be calculated).

The record template module 250 may select a template to instantiate a new data object. The selection may be based a user selection or based on a history of user actions (e.g., a frequency at which a user uses a workflow or task with the same schema). The record template module 250 may create a template based on an existing data object, where the template's schema matches the schema of the existing data object. In some embodiments, the record template module 250 may recommend a template for the user to apply. The record template module 250 may identify an existing data object in response to determining that a user has created data objects having the schema of the existing data object above a threshold number of times, or a “threshold creation number.” The record template module 250 may then generate, at a graphical user interface (GUI), a prompt recommending that the user create a template using the existing data object. If the user accepts the recommendation, the record template module 250 may create a template having the same schema as the identified data object. For example, if a user continues to create the same workflow for renting equipment for each episode of a TV series production, the record template module 250 may identify the workflow as being a data object whose creation meets the threshold creation number and prompt the user to create a template with the workflow's schema.

In some embodiments, the record template module 250 may generate a recommendation to use an existing template. The record template module 250 may receive a table from a user with a request reformat the table. If the user does not or has not yet specified a template to use, the record template module 250 may recommend an existing template to use. The record template module 250 may identify column names of the received table and in response to determining that the column names match a threshold number of definitions of a schema of an existing template, prompt the user to use the existing template to create a new data object. The record template module 250 may generate the prompt for display at a GUI.

The record template module 250 may calculate fields of data objects based on relative definitions. Examples of such calculations include calculating a date by using a specified date plus an offset, calculating an area of land by using a predetermined radius around a location, or calculating a budget estimate by using a target spend amount offset by some budgetary leeway.

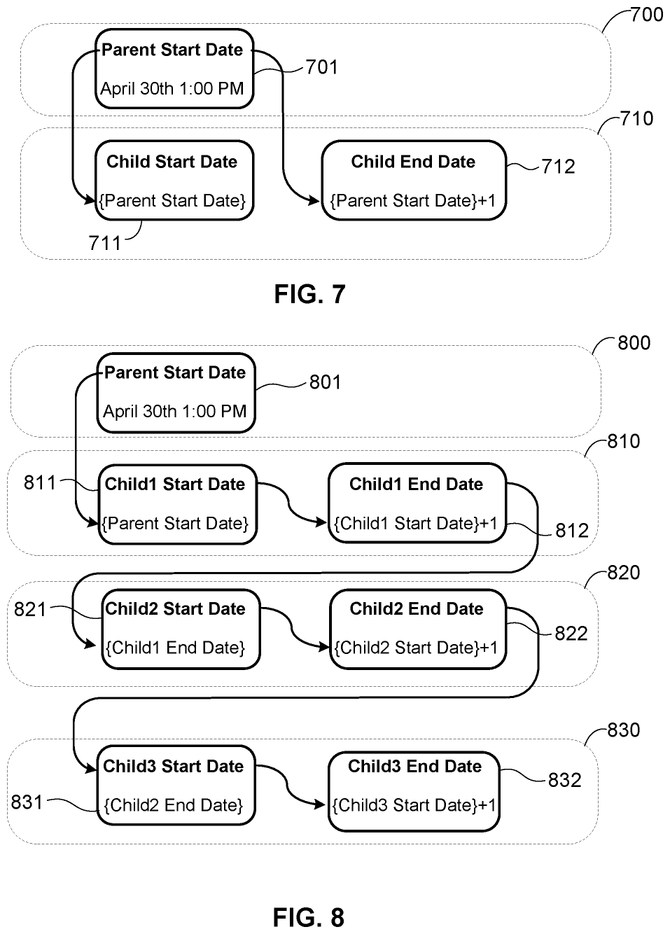

In some embodiments, the record template module 250 may create different types of relationships between data objects. In a first type of relationship, a parent data object is directly related to child data objects. Each of the child data objects may relate directly to the parent data object through a relative definition. The record template module 250 may calculate a field of each of the child data objects based on the relative definition. The record template module 250 may populate fields of the child data objects using the calculated field. One example of this type of relationship is shown in FIG. 7.

In a second type of relationship between data objects, the record template module 250 creates a relationship between a parent data object that is related to child data objects in a linear order (i.e., in a daisy-chain). In some embodiments, a record template module 250 can use a record template to instantiate child data objects. The child data objects can relate to the parent data object in a linear series. For each of the child data objects, the record template module 250 can calculate a field of the child data object based on a base parameter either of another child data object or, if the child data object is directly related to the parent data object, of the parent data object. One example of this type of relationship is shown in FIG. 8.

In some embodiments, the record template module 250 may link an existing data object to a data object that does not yet exist (i.e., a pre-instantiated data object) or to an unknown field of an existing data object. The record template module 250 may define a linked field of a template, where the field is linked to a pre-instantiated data object. The definition of the linked field can cause the linked field to be a default value until the pre-instantiated data object is created. In response to determining that the pre-instantiated data object has been instantiated, the record template module 250 may update the value of the linked field based on the field of the newly-instantiated data object.

In one example of linking to a field before it is known, the record template module 250 may create data objects that depend from an unknown “total budget” field. When creating a workflow of tasks for producing a TV series, many of tasks may depend on the total budget for a given episode of the TV series. This total budget may be a field in a data object managed by the record template module 250. Rather than being unable to create any task dependent on the total budget while the total budget is unknown, the record template module 250 may continue to create data objects representing the necessary tasks while linking back to the unknown total budget. In this way, the record template module 250 links a data object to a data object or field that does not yet exist. Once the total budget has been determined and updated, the record template module 250 may propagate the update to linked data objects having fields whose values depend on the total budget (e.g., updating the budget for catering based on the total budget).

In one example of linking to a pre-instantiated data object, the record template module 250 may create data objects that depend from an “actor” data object that does not yet exist. Following the previous TV series production context, a producer may use the record template module 250 to organize tasks for an actor before the actor is cast. Tasks for the actor such as traveling to a filming site, doing press tours, or meeting with an accent coach may be represented as data objects by the record template module 250, where the tasks are linked to a pre-instantiated data object designed to be instantiated once the actor is cast. Until the actor is cast and the data object is newly-instantiated, the record template module 250 may use a default value (e.g., the name of the character that the actor is portraying) throughout the dependent data objects. In response to determining that the pre-instantiated data object has been instantiated with the casted actor's information, the record template module 250 may update the value of the linked field based on the newly-instantiated data object.

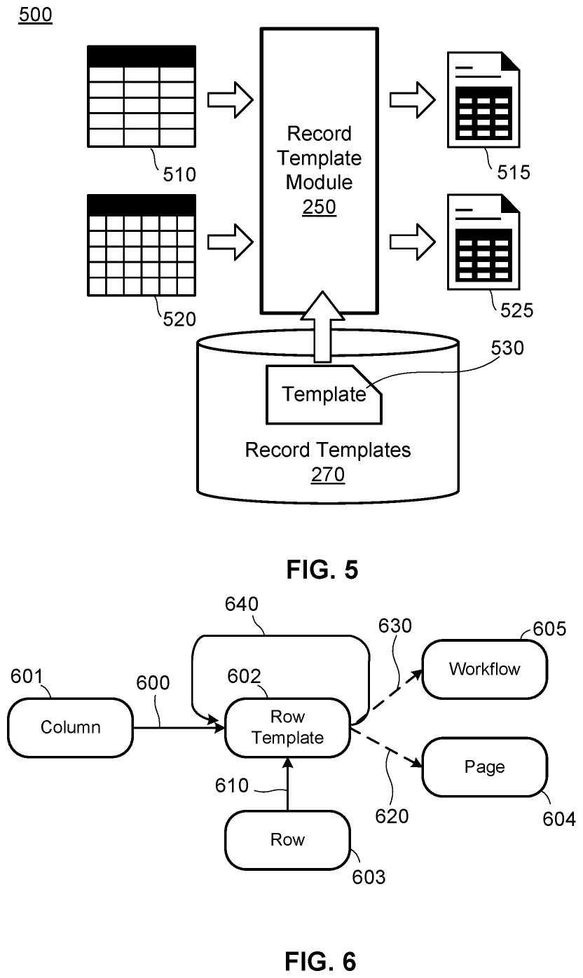

The record template module 250 may apply a template to differently formatted tables to obtain data objects populated with the respective table's data according to the template's schema. That is, the record template module 250 has flexibility to be applied to different tables to produce a data object that has consistent formatting. This may be relevant for data from different organizations who organize their data differently but are required to present data in one standardized format (e.g., a report to a governing agency). The record template module 250 may receive a first table having a first set of column names and a second table having a second set of column names, where the first and second set of column names are not the same (i.e., at least one but not all column names are different between the two tables). The record template module 250 may then select a template to instantiate a first data object from the first table and a second data object from the second table. The first and second data objects are thus instantiated using the same schema (i.e., the template's schema). An example illustration of this instantiation is shown in FIG. 5.

The record template module 250 may access, create, edit, link, or perform other suitable interaction with records and record templates based on a column type within a table. The following Table 2 indicates how different column types behave the same or differently depending on whether the column type is instantiated in a record or a record template:

TABLE 2

| Column Type | Record & Record Template Behavior Comparison |
|---|---|
| TEXT | Same for both |
| MULTILINE_TEXT | Same for both |
| NUMBER | Same for both |
| MULTI_SELECT | May be the same for both or slightly diverge if record |
| | templates from existing row create, read, update, and delete |
| | (CRUD) semantics. Specifically, in a record template, the |
| | entire array cell value may be replaced as a whole for each |
| | update, as opposed to having individual array-based |
| | operations. This can make for a simpler interaction model. |
| SELECT | Same for both |
| FOREIGN_KEY | Behavior for rows: |
| | When linking to another table, this field is bi- |
| | directional |
| | When linking to the same table, this field is uni- |
| | directional |
| | Both can and should only be able to reference rows |
| | Behavior for templates: |
| | When linking to another table: |
| | If the tables have a parent-child table |
| | relationship setup, then this uni-directionally |
| | links from parent template to child templates |
| | and causes cascading creation. |
| | If not, then this uni-directionally links to |
| | existing rows. From the row perspective, the |
| | row does not appear as being linked to the |
| | template. In one example, the row may appear |
| | as linked only to the resulting row of the |
| | template after the template is instantiated. |
| | When linking to the same table, this field can either |
| | be: |
| | Linked to other templates. |
| | This implies that the linked template is |
| | also created along with the template. |
| | Otherwise, there may be no valid link |
| | after instantiation. |
| | Linked to existing records in the table. |
| DATE | Same for both |
| PHONE | Same for both |
| MULTIPLE_ATTACHMENT | May be the same, but in some embodiments, the system |
| | assumes that attachments are linked to a rowId. A template |
| | may include a process for linking the desired attachment to a |
| | rowID on instantiation. |
| CHECKBOX | Same for both |
| FORMULA | Relevant for rows. The rationale for this and the other |
| | computed column types below is that many of these have |
| | dependencies on data that exists. Record templates may |
| | characterize a schema of data that does not exist yet. |
| BARCODE | Same for both |
| COLLABORATOR | In some embodiments, a collaborator may be notified when a |
| | template is modified. Alternatively, templates may just not |
| | include this type of column. |
| MULTI_COLLABORATOR | See collaborator. In some embodiments, where collaborator |
| | functionality is included, the system may slightly diverge is |
| | record templates from existing row CRUD semantics. |
| | Specifically, in a record template, the entire array cell value |
| | may be replaced as a whole for each update, as opposed to |
| | having individual array-based operations. This can make for a |
| | simpler interaction model. |
| RATING | Same for both |
| RICH_TEXT | In some embodiments, this column type is the same for both a |
| | record and a record template. This column type may be |
| | implemented by a full value replace of every cell value |
| | update. |

A row template is not a conventional row of a table. Each row template may have a unique identifier for tracking data and handler operations. However, a row template may provide the same behavior as a row. Similarly, a row template cell exhibits some of the behavior of conventional cells, but not all. A conventional cell may support computational and ephemeral values. Additionally, a conventional cell may link a column only to other existing rows. By contrast, a row template may link a column to another row template in addition to linking a column to other existing rows. The row template may further support various definitions for values within a cell. For example, definitions can include definitions that are conditional upon a parent data object's value(s), relative to a parent data object's value(s), or require an input value. In some embodiments, both a row template and conventional row may support text values, number values, selecting multiple values, collaborators and the values input by the collaborators, rich text values, attachments, and handling cell value conversion upon a change in column type or type options.

In one embodiment, a row template may include the following columns: id (an identifier of the row template), applicationId (an identifier of the corresponding application), tableId (an identifier of the table), name, description, createdTime, deletedTime, initialCreatedTime, initialCreatedByUserId. The row template may be indexed by applicationId, tableId, and deletedTime.

The row template cells may be stored individually in a separate table. This is similar to what can be done for conventional cells. Generally, less partitioning can be used because there may be less template cells than conventional cells. The underlying value in a template can be stored as a nested discriminated type rather than a direct value so that the template cells can include links to children templates and relative values (e.g., relative dates). In addition, deletedTime may be tracked for templates to allow soft deletions, which may be more viable than with conventional cells given the relatively smaller number of template cells.

The record template module 250 may track dependencies between a row template and its linked descendent templates, the tables of the template and all linked descendent templates, the columns of the cell objects of the template and all linked descendent templates, and/or non-creation linked templates of all descendant linked templates. For example, the record template module 250 may maintain a table of dependencies update the table as dependencies are added, edited, or removed.

In one embodiment, when a template is instantiated, the record template module 250 can check that any required metadata to use the template is available. If the template is applied with an existing parent record, the record template module 250 can keep the parent record's existing defined values and fill in empty values using the template. Alternatively, if the template is applied without an existing parent record, the record template module 250 may create a record with the provided field values (e.g., provided by the user). The record template module 250 may create any children records defined by the template, evaluating relative and conditional fields. The record template module 250 can link together the newly created children records based on the relationships defined in the template. Finally, the record template module 250 may evaluate formulaic templated fields.

The mapping data 260 is stored on one or more computer-readable media that store tabular data mappings for one or more external servers 115. Although the mapping data 260 is shown as a single element within the server 110 for convenience, the mapping data 260 may be distributed across multiple computing devices (e.g., as a distributed database).

A user with suitable permissions to a pair of databases may select a subset of the data in a table in one database (e.g., a source table) to synchronize with a corresponding table in a second database (e.g., a target table). Thus, the two tables are referred to as partially synchronized, as only a subset of the rows or columns from the source table are used to populate the target table. However, it should be noted that complete synchronization is also possible, meaning all of the source table is synchronized with the destination table, and the destination table has not been enriched with any additional data (though it may be, depending upon the embodiment). As described below, a user can synchronize some or all data from multiple source databases to one table at one database.

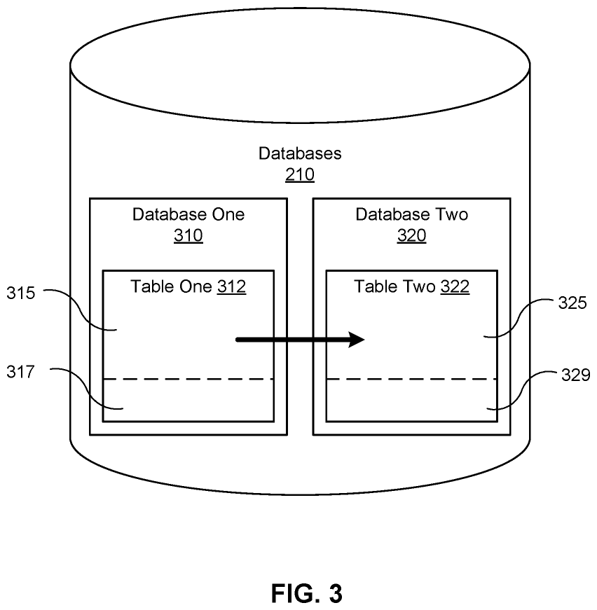

FIG. 3 illustrates the partial synchronization of two tables of two databases in the databases 210, according to one embodiment. In the embodiment shown, the databases 210 includes database one 310 and database two 320. In practice, the databases 210 will likely include many more (e.g., hundreds, thousands, or even millions of) databases. Database one 310 includes table one 312, which has a synchronized portion 315 and an unsynchronized portion 317. Database two 320 includes table two 322, which includes a synchronized portion 325 (which mirrors the synchronized portion 315 of table one 312 except for any differences that arose since the previous synchronization operation) and an enriched portion 329. The enriched portion 329 may include data added by users of database two 320, data synchronized from a third table, or both.

The third table in such a case may either be another table in database one 310 or from a third database (not shown). It should be noted that table two 322 is not limited to receiving synchronized data from just two tables. In theory, table two 322 may receive synchronized data from an unlimited number of other tables, limited only by computational and memory requirements. Similarly, synchronization is not limited to a single generation. Table two 322 may serve as a source table for a third destination table, which may in turn serve as a source table for another target table, etc. Furthermore, each synchronization relationship between a source table and a target table may share a different subset of data selected from either the synchronized portion 325, the enriched portion 329, or both.

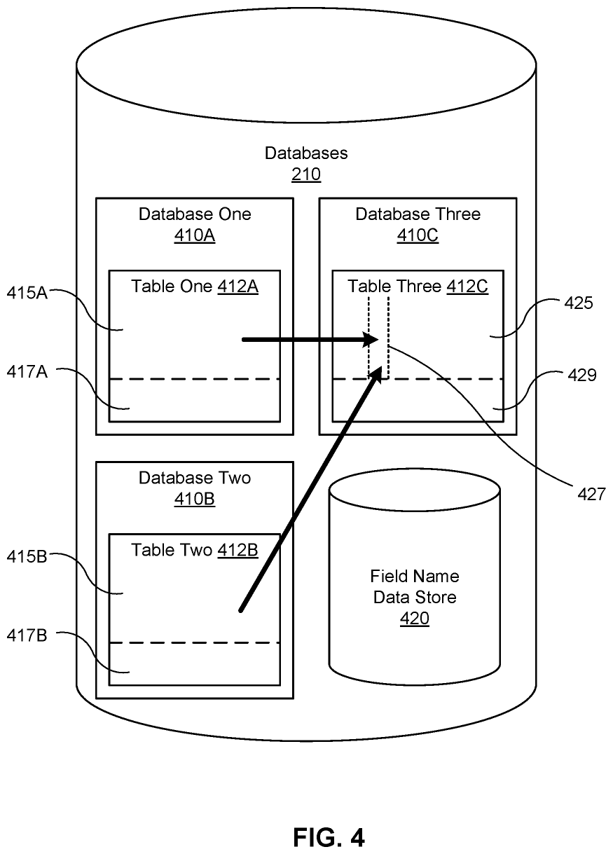

FIG. 4 illustrates multisource synchronization of three tables of three databases in the databases 210, according to one embodiment. In the embodiment shown, the databases 210 includes database one 410A, database two 410B, database three 410C, and a field name data store 420. Database one 410A includes table one 412A, which has a synchronized portion 415A and an unsynchronized portion 417A. Database two 410B likewise includes table two 412B, which has a synchronized portion 415B and an unsynchronized portion 417B. The field name data store 420 stores mappings between potential field names that have a high likelihood of being synonymous (e.g., “first name” and “given name”). The databases 210 may include additional databases or tables, depending upon the embodiment.

Database three 410C includes table three 412C, which includes a synchronized portion 425 and an enriched portion 429. The enriched portion 429 may include data added by users of database two 410B, data synchronized from a fourth table, or both. For example, the server 110 may receive user input data (e.g., data that a user input to a client device 140 and sent to the server 110) specifying additional one or more rows or columns to add to table three 410C.

In this embodiment, table three 412C includes a column 427 that synchronizes data from two sources, table one 412A and table two 412B. For example, column 427 includes ten records total, six received from table one 412A and four from table two 412B. A user administrating table three 412C (e.g., using a client device 140) sets table one 412A as the primary source. Depending upon the embodiment, the primary source may be automatically set by the server 110, e.g., based on which source is first synchronized to the column 427, or which source provides the most records to the column 427; the automatically set primary source may be updated by the user, in some embodiments. Source tables other than the primary source may be considered secondary sources.

The server 110 uses the primary source to determine the data type of the column 427. Data from other sources, e.g., table two 412B, is cast to the data type of the data from the primary source in the column. This resolves ambiguities which may arise from synchronizing columns of multiple source tables with different data types to one column in a target table.

For example, the column synchronized from table one 412A to the column 427 may have a data type “text,” where the column synchronized from table two 412B to the column 427 may have a data type “date.” Because table one 412A is the primary source, the server 110 sets column 427 as having data type “text” and casts data from table two 412B for column 427 as “text.”

The server 110 may also determine the field configuration for the column 427 based on the respective field configuration of the column at the primary source from which data is synchronized. In one embodiment, the primary source determines whether the column in the target table is removed when the source table's column is hidden or destroyed. For example, if a column of a primary source is removed from the source table, the server 110 removes the respective column from the target table, but if the corresponding column is removed from a different source table, only records in the target table corresponding to the different source table are affected (e.g., removed). For a target table with a single source table, the single source table can be considered to be the primary source for all fields.

The user also performs field mapping for synchronized fields from table one 412A and table two 412B to table three 412C. In the field mapping, the user sets a correspondence between a column at each source to a column at table three 412C. The server 110 initially attempts to match fields from sources to table three 412C according to field name, which the user can override via a user interface. The server 110 compares field names from synchronized columns of a source (e.g., table one 412A) to field names of synchronized columns in the target table (e.g., table three 412C) and, upon identifying a matching pair, maps the source field to the target field.

For example, table one 412A may include a “first name” field and a “last name” field, table two 412B may include a “given name” field, a “middle name” field, and a “surname” field, and table three 412C may include a “first name” field and a “family name” field. The server 110 matches the “first name” field from table one 412A to the “first name” field from table three 412C, indicating that data from the “first name” field of table one 412A will synchronize to the “first name” field of table three 412C. The user maps the “given name” field of table two 412B to the “first name” field of table three 412C, and the “last name” field of table one 412A and the “surname” field of table two 412B to the “family name” field of table three 412C. As such, data from table one 412A and table 412B will synchronize to the mapped fields in table three 412C.

In an embodiment, the server 110 auto-matches columns with synonymous field names, as determined according to the field name data store 420. The field name data includes mappings between field names that are likely to be synonymous. Thus, the server 110 can use the field name data to identify columns with different but synonymous names as likely matches. The matches can be automatically applied or presented to the user as suggestions for verification.

FIG. 5 depicts a diagram 500 for instantiating data objects using the record template module 250, in accordance with at least one embodiment. The record template module 250 applies a template 530 to tables 510 and 520. The record template module 250 generates data objects 515 and 525 using the template 530 based on tables 510 and 520, respectively. The template 530 may be accessed by the record template module 250 from the record templates 270. The tables 510 and 520 may be representable by the same or different row templates. The record template module 250 may identify, using column names specified in a row template, definitions included within the template schema of the template 530.

FIG. 6 is a diagram illustrating a process for incorporating a row template into a dependency graph for a database, according to one embodiment. A column of a table may be tracked in a dependency graph, where the column is assigned to a row template. The record template module 250 may use the dependency graph to look up a row template assigned to a column. Additionally, a row may be assigned to the row template. In this way, a row template depends on both a column and a row. Within the row defined by the row template, the record template module 250 can define a workflow(s) and/or page(s) in certain fields (or cells). The record template module 250 may cause a workflow and/or a page to be instantiated based on a row template. A workflow may be a set of operations. For example, a workflow may specify that “X needs to be done before Y and takes two days. Y needs to be done before Z and takes five days.” If a template triggers a workflow, the record template module 250 can use relative values that define a workflow to calculate actual values in a present instantiation and create the data object (e.g., a linked table). A page may be a set of data that is linked to from a cell.

In the example process shown in FIG. 6, the record template module 250 accesses 600 a column 601 that is assigned to a row template 602, where the column may be a part of a table. Having access to the row template 602, the record template module 250 then inputs 610 data from a row 603 into the row template 602. Optionally, as indicated by dashed lines, the record template module 250 may cause a workflow 605 and/or a page 604 to be instantiated 630 and 620 based on the row template 602. The record template module 250 iterates 640 through each row and column. Thus, the record template module 250, for each column of a table, accesses a row template corresponding to the table, identifies a row value at the column, and determines, using the row value, whether to instantiate a new workflow or a new page.

FIG. 7 depicts a first type of relationship between a parent data object 700 and a child data object 710, in accordance with one embodiment. Data objects 700 and 710 are depicted with limited data content (e.g., fields 701, 711, and 712) for clarity, but may include additional data content, which may also be related to other data objects. Although data content described in FIG. 7 is dates, the record template module 250 may create dependencies with other types of data content (e.g., budget dependencies, ingredient dependencies, people dependencies, location dependencies, etc.).

The record template module 250 may create the dependent relationship between the parent data object 700 and the child data object 710. The record template module 250 may generate the parent data object 700 using a template schema that includes a definition for data content in a parent start date field 701. The definition may specify a relationship between the field 701 and one or more fields of one or more child data objects. This definition that specifies a relationship between fields of data objects may also be referred to as a “relative definition.”

In the example depicted, the record template module 250 may use the relative definition to create a relationship between the field 701 and a child start date field 711 and a child end date field 712 of the child data object 710. Both the fields 711 and 712 support values that are specified relative to the parent data object 700. In this way, a user may avoid manually inputting the values for the fields 711 and 712, and the record template module 250 can automatically configure the values (i.e., a first date and a number of days offset from that first date, where the first date is obtained from the parent data object 700).

FIG. 8 depicts a second type of relationship between a parent data object 800 and child data objects 810, 820, and 830, in accordance with one embodiment. Data objects 800, 810, 820, and 830 are depicted with limited data content (e.g., fields 801, 811, 812, etc.) for clarity, but may include additional data content, which may also be related to other data objects. Although data content described in FIG. 8 is dates, the record template module 250 may create dependencies with other types of data content (e.g., budget dependencies, ingredient dependencies, people dependencies, location dependencies, etc.).

The record template module 250 may create dependent relationships between the parent data object 800 and the child data objects 810, 820, and 830. The record template module 250 may use a template schema to generate the parent data object 800, where the template schema includes a definition specifying these dependent relationships. The record template module 250 may instantiate the child data objects 810, 820, and 830 having interrelated date fields 801, 811, 812, 821, 822, 831, and 832. In particular, the date fields have a sequential or daisy-chain dependency: child end date field 832 is linked to and depends on child start date field 831, child start date field 831 is linked to and depends on child end date field 822, child end date field 822 is linked to and depends on child start date field 821, and so on until the parent start date field 801, which is linked to child start date field 811. The record template module 250 not only creates dependencies within a single data object (e.g., within the data object 820, the field 822 depends from the field 821), but also creates dependencies between multiple data objects (e.g., the data object 830 depends from the value of a field within the data object 820). In this way, a child data object's dates are specified based upon other children's dates, in a linear order. One benefit of this is that the record template module 250 may update one data object's field and automatically also update other data objects' fields that are related by the dependent relationships (e.g., child data objects).

In some embodiments, the record template module 250 may calculate relative dates that account for weekends and holidays such that, for example, one day after a Friday is a Monday (or a Tuesday if the Monday is a holiday). This may be a configurable option as to whether to skip weekends and/or holidays, and which holidays to include in the list to skip (if any). The record template module 250 may, when updating a field whose value is specified by a relative definition, determine that the initially determined value (e.g., a base parameter modified by an offset parameter) is a date that conflicts with a weekend or a holiday. In response, the record template module 250 may then update the date to remove the conflict (e.g., update the date to the next day of the week that is not a weekend or holiday).

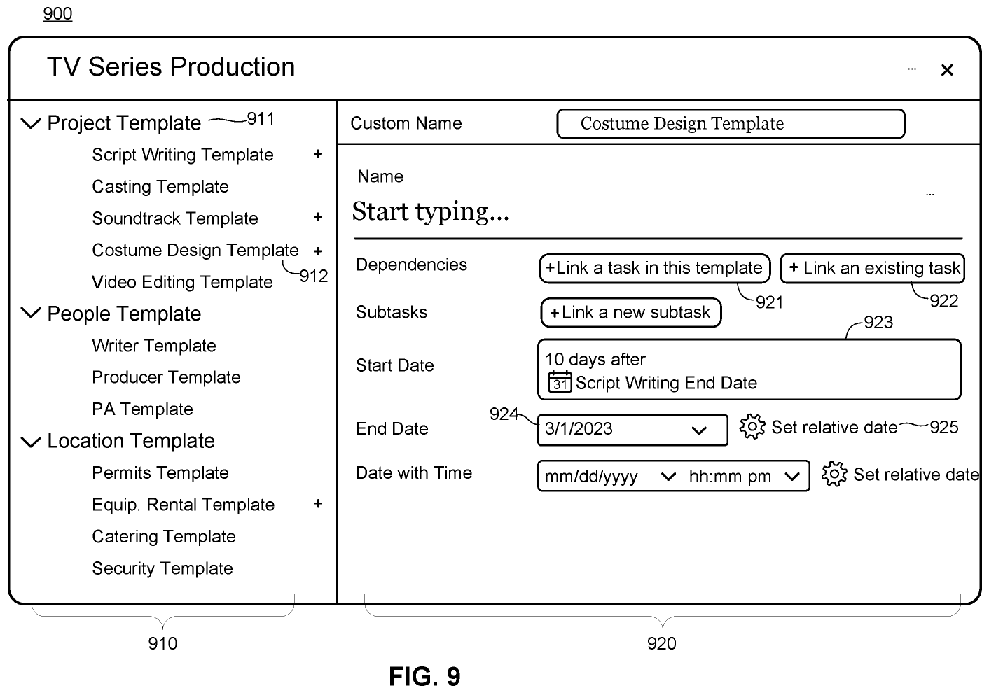

FIG. 9 depicts a GUI 900 for adding, modifying, and linking templates, in accordance with one embodiment. The record template module 250 may generate the GUI 900 for display at a client device and receive user inputs provided to the client device. The GUI 900 includes a template index 910 and an editing window 920.

The template index 910 includes a list of templates managed by the record template module 250, where the list may be arranged based on relationships and/or a hierarchy among the templates. As illustrated, the list of templates includes a hierarchy of templates. For example, the project template 911 is a template that is above a costume design template 912 in the hierarchy of templates. A user may customize this hierarchy via the GUI 900 and the record template module 250 may maintain the customized hierarchy for the user. A user may select a template from the template index 910 for editing at the editing window 920.

The editing window 920 is an interface for the user to create, add, and/or link a template. As depicted in FIG. 9, the editing window 920 is presently displayed for editing the costume design template 912. The editing window 920 includes input elements 921 and 922 to link a new or existing task to the template 912, respectively. In response to a user selecting the input element 921, the record template module 250 may generate for display an interface for the user to create a new task to be linked to the template. For example, the record template module 250 may generate an interface for the user to create a task for submitting initial drafts of costume designs. The record template module 250 may instantiate and link the “initial drafts” task in response to the user selecting the input element 921.

The record template module 250 may link the costume design template 912 to an “initial drafts” task that has not yet been instantiated. The record template module 250 may use a dummy value as a placeholder for the “initial drafts” task. Additionally, in response to a user selecting the input element 922, the record template module 250 may generate for display an interface for the user to link an existing task to the template 912. The editing window 920 may also be used to link a new subtask. A subtask is one part of a task (e.g., where a task is to “make dinner,” a subtask may be “chop vegetables” or “boil chopped vegetables”). A dependency is a relationship between tasks and/or subtasks (e.g., “boil chopped vegetables” cannot be performed without first “chop vegetables” being complete).

The editing window 920 includes input elements for modifying one or more date fields. The schema of the costume design template 912 includes a start date field and an end date field. The record template module 250 includes an input element 923 enabling the user to specify a start date field definition (e.g., a relative definition). As depicted in FIG. 9, the start date field has already been specified by the user to be on a date that is ten days after when script writing ends (i.e., the value of an end date field from the script writing template). In this example, the date that the script writing ends can be referred to as a base parameter and the ten day offset may be referred to as a dependent offset. The end date field can be modified by input elements 924 and 925. A user may select a base parameter (i.e., a date) via the input element 924. The record template module 250 may create a relative definition in the costume design template's schema in response to the user selecting the input element 925 to create a relative date. The relative definition may include a dependent offset and base parameter similar to the value of the start date field.

In some embodiments, the record template module 250 may generate for display a GUI for using record templates. The record template module 250 may load the names, descriptions, and children relationships of all row templates in a database. Loading data refers to the retrieval of data from a memory to enable quick use of the data. The loaded data may also be generated for display by the record template module 250. Hence, loading data enables display of the relevant information in the GUI without significant delay. The children relationships may be represented as cell objects within a data structure. The same cell object may be used to represent loaded and unloaded templates. The record template module 250 can track the load status of a cell object. When a user clicks or otherwise selects a specific template for editing, the record template module 250 can load the parent template's cell values and then may either load all child data object templates' cell values in the background, or on-demand when a user clicks on a child data object template. In response to receiving a user indication that they have completed editing, the record template module 250 may release the loaded data from memory.

### Example Methods

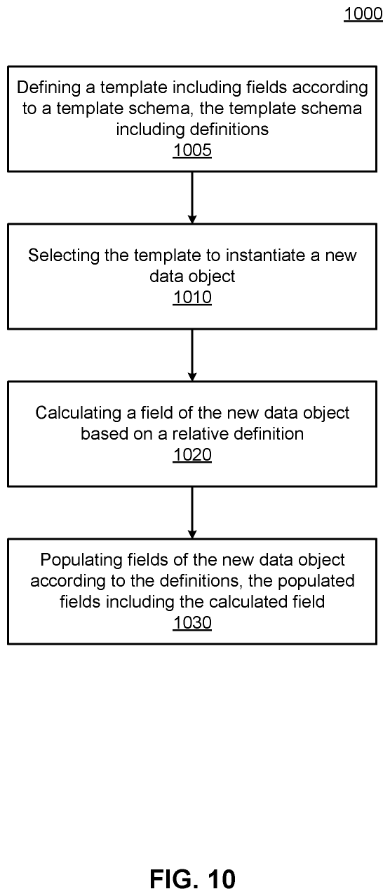

FIG. 10 illustrates a method 1000 for instantiating a data object, in accordance with one embodiment. The steps of FIG. 10 are illustrated from the perspective of the server 110 performing the method 1000. However, some or all of the steps may be performed by other entities or components. In addition, some embodiments may perform the steps in parallel, perform the steps in different orders, or perform different steps.

In the embodiment shown in FIG. 10, the method 1000 begins with the server 110 defining 1005 a template that includes fields according to a template schema. The template schema includes an arrangement of the fields and definitions for data content of the fields. The definitions may include a relative definition for data content that is relative to other data. The server 110 then selects 1010 the template to instantiate a new data object, which can have a data schema corresponding to the template schema. The server 110 then calculates 1020 a value of a relative field of the new data object based on the relative definition. The term “relative field” refers to a field whose value is calculated based on a relative definition. Finally, the server 110 populates 1030 fields of the new data object according to the definitions including populating the relative field with the calculated value.

In some embodiments, the server 110 may perform different steps to populate fields of instantiated child data objects. For example, the server 110 may verify that metadata required to use a template is available. The server 110 may then populate fields in a parent data object using the template. In response to the template including a definition defining one or more child data objects, the server 110 may create the one or more child data objects having data relative to data of the parent data object. The server 110 may link the one or more child data objects to the parent data object and determine values of fields of the child data objects based on the definitions in the template's schema, where at least one of those values is calculated using the relative definition. Finally, the server 110 populates the fields of those child data objects with the determined values.

### Computing System Architecture

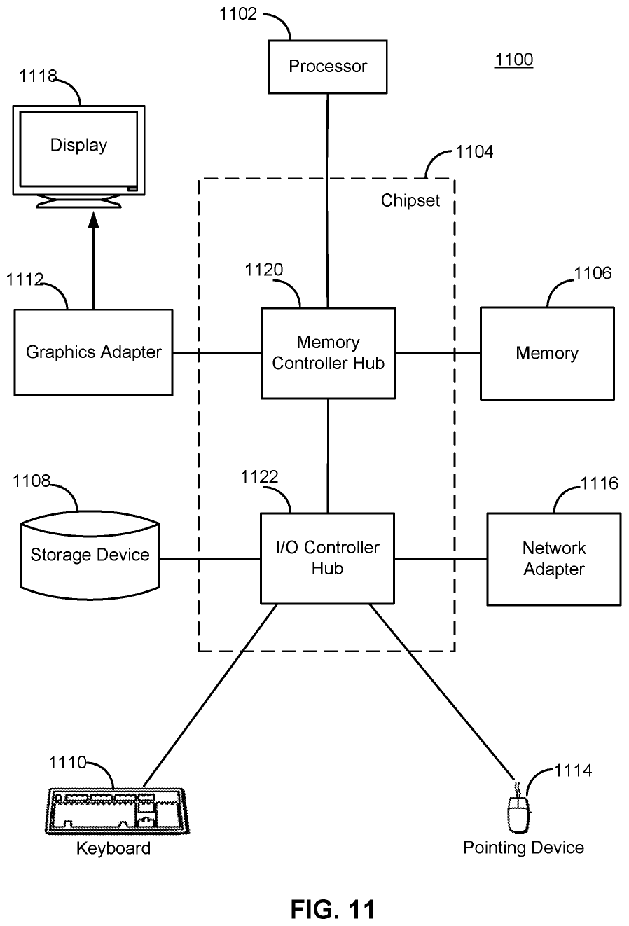

FIG. 11 is a block diagram illustrating an example computer 1100 suitable for use as a server 110, external server 115, or client device 140. The example computer 1100 includes at least one processor 1102 coupled to a chipset 1104. The chipset 1104 includes a memory controller hub 1120 and an input/output (I/O) controller hub 1122. A memory 1106 and a graphics adapter 1112 are coupled to the memory controller hub 1120, and a display 1118 is coupled to the graphics adapter 1112. A storage device 1108, keyboard 1110, pointing device 1114, and network adapter 1116 are coupled to the I/O controller hub 1122. Other embodiments of the computer 1100 have different architectures.

In the embodiment shown in FIG. 11, the storage device 1108 is a non-transitory computer-readable storage medium such as a hard drive, compact disk read-only memory (CD-ROM), DVD, or a solid-state memory device. The memory 1106 holds instructions and data used by the processor 1102. The pointing device 1114 is a mouse, track ball, touchscreen, or other type of pointing device, and is used in combination with the keyboard 1110 (which may be an on-screen keyboard) to input data into the computer system 1100. The graphics adapter 1112 displays images and other information on the display 1118. The network adapter 1116 couples the computer system 1100 to one or more computer networks.

The types of computers used by the entities of FIGS. 1 through 10 can vary depending upon the embodiment and the processing power required by the entity. For example, the server 110 might include a distributed database system comprising multiple blade servers working together to provide the functionality described. Furthermore, the computers can lack some of the components described above, such as keyboards 1110, graphics adapters 1112, and displays 1118.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing and using record templates. Thus, while particular embodiments and applications have been illustrated and described, it is to be understood that the described subject matter is not limited to the precise construction and components disclosed. The scope of protection should be limited only by any claims that ultimately issue.

What is claimed is:

1. A non-transitory computer-readable storage medium storing computer program instructions, which when executed by one or more processors of a computing device, cause the computing device to perform operations comprising:
defining a template including fields according to a template schema, the template schema including an arrangement of the fields and definitions for data content of the fields, wherein the definitions include a relative definition for data content that is relative to other data;
selecting the template to instantiate a new data object, the new data object having a data schema corresponding to the template schema;
calculating a value of a relative field of the new data object using the relative definition; and
populating fields of the new data object according to the definitions including populating the relative field with the calculated value.

2. The non-transitory computer-readable storage medium of claim 1, wherein calculating the value of the relative field comprises:
identifying a source value of a base parameter;
determining a dependent offset based on the base parameter; and
modifying the source value using the dependent offset to obtain the value of the relative field.

3. The non-transitory computer-readable storage medium of claim 2, wherein the base parameter is a first date, and to the operations further comprise:
determining that the value of the relative field conflicts with a weekend or a holiday; and
updating the value of the relative field to remove the conflict.

4. The non-transitory computer-readable storage medium of claim 1, wherein the operations further comprise:
instantiating a child data object according to the data schema, wherein the child data object includes at least one field that is relative to the new data object;
calculating a value of a child field of the child data objects using a corresponding relative definition; and
populating the child field using the calculated value.

5. The non-transitory computer-readable storage medium of claim 1, wherein the operations further comprise:
instantiating child data objects that relate to the new data object in a linear series; and
for each of the child data objects:
calculating a value of a child field of the child data object based on a base parameter of one of another child data object or the new data object to which the child data object is directly related, and
populating the field of the child data object using the calculated value.

6. The non-transitory computer-readable storage medium of claim 1, wherein the relative definition comprises one of a date modification, a geographic modification, or a duration modification.

7. The non-transitory computer-readable storage medium of claim 1, wherein the operations further comprise:
defining a linked field of the template that is linked to a pre-instantiated data object, wherein the definition of the linked field causes the linked field to be a default value until the pre-instantiated data object is created; and
in response to determining the pre-instantiated data object has been newly instantiated, updating the value of the linked field based on a field of the newly-instantiated data object.

8. The non-transitory computer-readable storage medium of claim 1, wherein the operations further comprise:
receiving a first table having a first set of column names and a second table having a second set of column names, wherein the first and second set of column names are not the same; and
selecting the template to instantiate a first data object corresponding to the first table and a second data object corresponding to the second table, the first and second data objects both having the data schema.

9. The non-transitory computer-readable storage medium of claim 1, wherein the operations further comprise:
creating the template based on an existing data object, wherein the template schema matches the schema of the existing data object.

10. The non-transitory computer-readable storage medium of claim 9, wherein the operations further comprise:
identifying the existing data object in response to determining a user has created data objects having the schema of the existing data object above a threshold creation number; and
generating, at a graphical user interface (GUI), a prompt recommending the user create the template using the existing data object.

11. The non-transitory computer-readable storage medium of claim 1, wherein the operations further comprise:
receiving a table from a user;
identifying column names of the table; and
in response to determining the column names correspond to a threshold number of definitions of the template schema, generating, at a GUI, a prompt recommending the user use the template to create the new data object.

12. The non-transitory computer-readable storage medium of claim 1, wherein the operations further comprise:
generating for display a GUI comprising names, descriptions, and child relationships of templates of tables, wherein each template includes column names for the respective tables.

13. The non-transitory computer-readable storage medium of claim 1, wherein the operations further comprise:
generating child relationships between data objects at the GUI using cell objects, wherein the same cell object is used to represent templates generated for display and defined templates and not presently generated for display.

14. The non-transitory computer-readable storage medium of claim 1, wherein the operations further comprise:
in response to selecting the template, instantiating a child data object related to the new data object, the child data object corresponding to a subtask of a task represented by the new data object.

15. The non-transitory computer-readable storage medium of claim 1, wherein the operations further comprise:
defining a hierarchy of relationships between a pair of data objects, wherein a relationship is between a given template and linked children templates, between a table of the given template and the linked children templates, or between a pre-instantiated data object and the linked children templates.

16. The non-transitory computer-readable storage medium of claim 1, wherein the operations further comprise:
for each column of a table:
accessing a row template corresponding to a respective row of the table;
identifying a row value at the column; and
determining, using the row value, whether to instantiate a new workflow or a new page.

17. A computer-implemented method comprising:
defining a template including fields according to a template schema, the template schema including an arrangement of the fields and definitions for data content of the fields, wherein the definitions include a relative definition for data content that is relative to other data;
selecting the template to instantiate a new data object, the new data object having a data schema corresponding to the template schema;
calculating a value of a relative field of the new data object using the relative definition; and
populating fields of the new data object according to the definitions including populating the relative field with the calculated value.

18. The computer-implemented method of claim 17, further comprising:
instantiating a child data object according to the data schema, wherein the child data object includes at least one field that is relative to the new data object;
calculating a value of a child field of the child data objects using a corresponding relative definition; and
populating the child field using the calculated value.

19. The computer-implemented method of claim 17, further comprising:
instantiating child data objects that relate to the new data object in a linear series; and
for each of the child data objects:
calculating a value of a child field of the child data object based on a base parameter of one of another child data object or the new data object to which the child data object is directly related, and
populating the field of the child data object using the calculated value.

20. A non-transitory computer-readable storage medium storing computer program instructions, which when executed by one or more processors of a computing device, cause the computing device to perform operations comprising:
verifying that metadata required to use a template is available, wherein the template has a template schema including an arrangement of fields and definitions for data content of each field, wherein the definitions include a relative definition for data content that is relative to other data;
populating fields in a parent data object using the template;
in response to the template including a definition defining one or more child data objects, creating the one or more child data objects having data relative to data of the parent data object;
linking the one or more child data objects to the parent data object;
determining values of fields of the child data objects based on the definitions, wherein at least one of the values is calculated using the relative definition; and
populating the fields of the child data objects with the determined values.
